(19) United States
(12) Patent Application Publication
(10) Pub. No.: US 2009/0213793 A1
(43) Pub. Date: Aug. 27, 2009

(54) Radio base station apparatus

(75) Inventor: Mitsuhiro Takashima, Tokyo (JP)

Correspondence Address: BACON & THOMAS, PLLC, 625 SLATERS LANE, FOURTH FLOOR, ALEXANDRIA, VA, 22314-1176, US

(73) Assignee: Hitachi Kokusai Electric Inc., Tokyo (JP)

(21) Appl. No.: 12/379,138

(22) Filed: Feb. 13, 2009

(30) Foreign Application Priority Data
Feb. 25, 2008 (JP) 2008-043627

(51) Int. Cl. H04W 88/08

(52) U.S. Cl. 370/328

(57) ABSTRACT

A media access control unit of a radio base station apparatus includes: a resource table for storing resource block numbers in order to reserve resource blocks for the packet data; a system information memory unit for storing a parameter used to determine whether to update information stored in the resource table; and a scheduler. When the parameter indicates update, the scheduler selects resource blocks spaced apart from each other in frequency and having a good radio quality, updates the resource table by using resource block numbers corresponding to the selected resource blocks, and performs persistent scheduling and distributed transmission scheduling on the packet data by using the resource blocks corresponding to the resource block numbers stored in the resource table.

### FIELD OF THE INVENTION

The present invention relates to a radio base station apparatus; and, more particularly, to a radio base station apparatus capable of reducing processing burden, improving radio quality, and raising utilization efficiency of radio resources.

### BACKGROUND OF THE INVENTION

In a radio communications system, radio communications are realized between radio base station apparatuses and terminal devices by using, for example, an Orthogonal Frequency Division Multiplexing (OFDM) transmission method.

A wide band radio communications system may be realized by employing the OFDM transmission method, wherein as a measure for a frequency selective fading caused by delayed waves, data are transmitted by multiplexing orthogonal narrow band sub-carriers.

In a third and next generation mobile phone system, the OFDM transmission method has been examined in the Third Generation Partnership Project (3GPP) in order to realize a high speed downlink (refer to Non-patent Document 1).

In a downlink from the radio base station apparatus to a terminal in the OFDMA (OFDM Access) system, the radio base station schedules transmission data to frequency regions of good radio quality, thereby improving throughput.

Communications may include, for example, file data, e.g., a small amount real-time Voice over Internet Protocol (VoIP) data, a large amount real-time streaming data, and non-real-time image file data.

Further, Patent Document 1 is a prior art related to a radio base station apparatus.

Patent Document 1 discloses a radio base station apparatus having a resource state monitoring unit which monitors the state of user resources in call processing, and notifies a call processing control unit when an abnormal state occurs. The resource state monitoring unit uses free resources to return an uplink signal of a spurious signal for confirmation, and confirms the user resources with a downlink signal. Further, when the abnormal state is detected, the place where the abnormal state occurs is located and counteracting measure is specified.

[Patent Document 1] Japanese Patent Laid-open Application No. 2006-20143

[Non-patent Document 1] 3GPP TR 25.814 [http://www.3gpp.org/]

### (When Frequency Diversity Cannot be Acquired: FIG. 6)

However, in a radio base station apparatus, when resource blocks (RBs) for VoIP packet data are allocated on a frequency axis and then transmitted, there are problems in that, when RBs having good radio quality are selected to be adjacent to each other as shown in FIG. 6, frequency diversity cannot be acquired, and the load on a Medium Access Control (MAC) function unit increases because RBs having good radio quality are required to be searched for in order to acquire frequency diversity.

FIG. 6 is a view showing the allocation of RBs in the case in which frequency diversity cannot be acquired.

### (Allocation of Free Rb: FIG. 7)

Further, when there is a user who requires VoIP service, a scheduler for scheduling transmission data searches for RBs which ensure frequency diversity. However, if a plurality of RBs has scheduled as shown in FIG. 7, the newly scheduled RBs may not have good radio quality, and there is a problem in that an RB searching process increases the load on the MAC function unit.

FIG. 7 is a view showing RB allocation in the case where allocation is performed on free RBs.

### (Fragmentary Allocation of Rb: FIG. 8)

If RBs are separately allocated based on persistent scheduling for respective users who take the VoIP service, the RBs are fragmented as shown in FIG. 8, so that there is a problem in that resource utilization is deteriorated.

FIG. 8 is a view showing the allocation of RBs in the case where the RBs are fragmentarily allocated.

### SUMMARY OF THE INVENTION

In view of the above, the present invention provides a radio base station apparatus capable of reducing processing burden, improving radio quality, and raising utilization efficiency of radio resources.

In accordance with an aspect of the present invention, there is provided a radio base station apparatus including a radio link control unit for outputting packet data to be transmitted to terminal devices; a media access control unit for scheduling the packet data; and a base band unit for processing baseband signals of a reception signal and a transmission signal.

The media access control unit includes: a resource table for storing resource block numbers in order to reserve resource blocks for the packet data; a system information memory unit for storing a parameter used to determine whether to update information stored in the resource table; and a scheduler for, when the parameter indicates update, selecting resource blocks spaced apart from each other in frequency and having good radio quality, updating the resource table by using resource block numbers corresponding to the selected resource blocks, and performing persistent scheduling and distributed transmission scheduling on the packet data by using the resource blocks corresponding to the resource block numbers stored in the resource table.

In accordance with the aspect of the present invention, the radio base station apparatus includes the media access control unit having the scheduler. The scheduler selects resource blocks each having distanced frequencies and a good radio quality, updates the resource table by using resource block numbers corresponding to the selected resource blocks, and performs distributed transmission-based persistent scheduling and on the packet data by using the resource blocks corresponding to the resource block numbers stored in the resource table, so that there is an advantage of reducing processing burden and improving a usability of radio resources, thereby improving a radio quality.

### BRIEF DESCRIPTION OF THE DRAWINGS

The objects and features of the present invention will become apparent from the following description of embodiments given in conjunction with the accompanying drawings, in which:

FIG. 1 is a block diagram showing the configuration of a radio base station apparatus in accordance with an embodiment of the present invention;

FIG. 2 is a view showing an example of the allocation of RB numbers and a state of a resource table;

FIG. 3 is a view showing a configuration of the allocation of RBs for persistent scheduling;

FIG. 4 is a view showing distributed transmission of a packet;

FIG. 5 is a view showing a method of scheduling RBs in a case where packets for a plurality of users are generated at the same time;

FIG. 6 is a view showing the allocation of RBs in a case where frequency diversity cannot be acquired;

FIG. 7 is a view showing RB allocation in a case where allocation is performed on free RBs; and

FIG. 8 is a view showing the allocation of RBs in a case where the RBs are fragmentarily allocated.

### DETAILED DESCRIPTION OF THE EMBODIMENTS

Hereinafter, embodiments of the present invention will be described in detail with reference to the accompanying drawings which form a part hereof.

In a radio base station apparatus in accordance with an embodiment of the present invention, a media access control unit includes a resource table for storing resource block numbers in order to reserve resource blocks for packet data; a system information memory unit for storing a parameter used to determine whether to update information stored in the resource table; and a scheduler. When the parameter indicates update, the scheduler selects resource blocks having good radio quality and spaced apart from each other in frequency; updates the resource table with resource block numbers corresponding to the selected resource blocks; and performing persistent scheduling and distributed transmission scheduling on the packet data by using the resource blocks corresponding to the resource block numbers stored in the resource table. As a consequence, processing burden can be reduced and radio quality can be improved while raising utilization efficiency of radio resources.

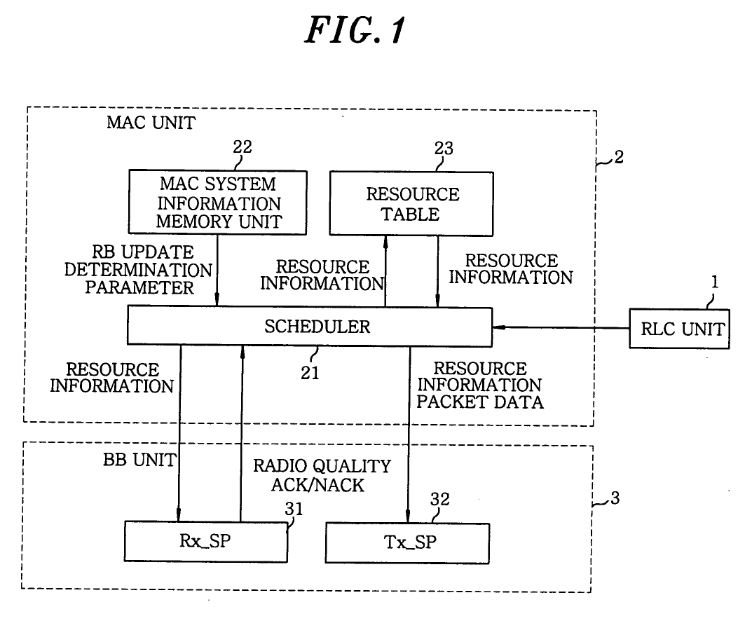

### (Configuration of Radio Base Station Apparatus: FIG. 1)

The radio base station apparatus in accordance with the embodiment of the present invention will be described with reference to FIG. 1.

The apparatus includes a radio link control unit (RLC) 1, a media access control (MAC) unit 2, and a base band (BB) unit 3, as shown in FIG. 1.

The RLC unit 1 outputs to the MAC unit 2 packet data to be transmitted to a terminal device.

The MAC unit 2 schedules resource blocks (RBs) in a frequency region on a frequency axis, determines a modulation method and RB location and the like, and then outputs the determined information as resource information (RB information) to the BB unit 3, together with packet data of RB.

The BB unit 3 performs baseband signal processing on a reception signal and a transmission signal based on the RB information.

Parts of the apparatus will be described in detail.

The MAC unit 2 includes a scheduler 21, a MAC system information memory unit 22, and a resource table 23.

The BB unit 3 includes a reception signal processing unit (Rx_SP) 31 and a transmission signal processing unit (Tx_SP) 32.

The scheduler 21 schedules the packet data received from the RLC unit 1 by using a method which will be described later, determines the RB location, modulation method and coding method, and sets them in the transmission signal processing unit 32 as the RB information.

Further, the scheduler 21 allocates numbers (RB numbers) to the RBs in a system band.

Further, as the modulation method, for example, a QPSK (Quadrature Phase Shift Keying) method or a QAM (Quadrature Amplitude Modulation) method may be used, and it is also possible to employ one of them by adoptively carrying out switch-over between them depending on the state of radio quality.

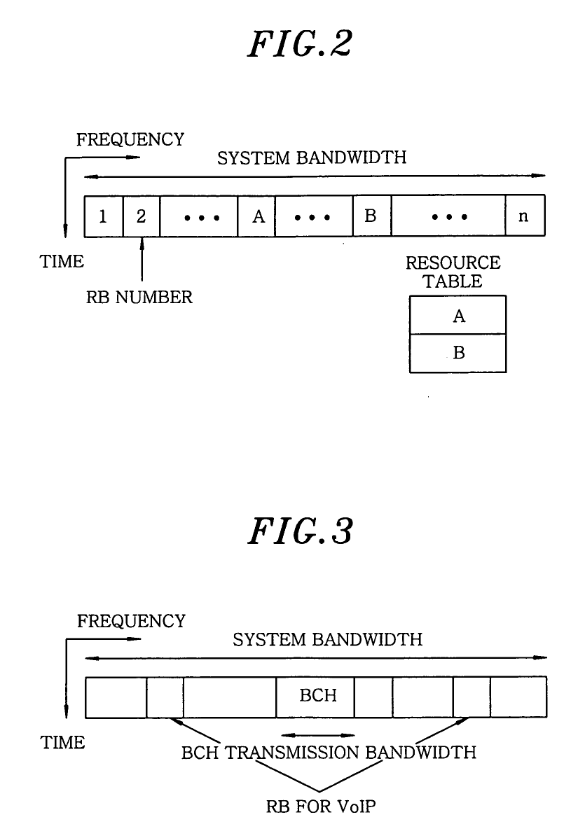

### (Resource Table 23: FIG. 2)

The resource table 23 stores the RB numbers of RBs to be scheduled.

An example of the allocation of RB numbers and the configuration of the resource table are shown in FIG. 2. In FIG. 2, two RB numbers are set in the resource table 23.

The resource table 23 stores a plurality of RB numbers in order to reserve the RB numbers in advance, and relevant RB numbers are updated. In this example, two RB numbers are stored.

### (Mac System Information Memory Unit 22)

The MAC system information memory unit 22 stores information about the MAC system (MAC system information), and, for example, stores information (parameters) indicating whether to use fixed RBs or to dynamically update the RBs. The MAC system information can be modified from the outside.

The reception signal processing unit (Rx_SP) 31 processes a baseband signal of a reception signal, and, in particular, processes a baseband signal of a reception signal received from an antenna based on the RB information including demodulation method set by the MAC unit 2.

Further, the reception signal processing unit 31 outputs, for example, a CQI (Channel Quality Indicator) for each frequency band in a frequency region on the frequency axis, which is used to execute adaptive modulation, and a transmission result (ACK or NACK) for a communication counterpart, which is received from the corresponding communication counterpart, to the scheduler 21 of the MAC unit 2.

### (Transmission Signal Processing Unit 32)

The transmission signal processing unit (Tx_SP) 32 processes a baseband signal of a transmission signal, and, in particular, receives the packet data scheduled by the scheduler 21 of the MAC unit 2, and then performs the baseband signal processing in order to transmit the packet data based on the RB information (modulation method, RB location and the like) set by the scheduler 21.

Thereafter, the transmission signal is wirelessly transmitted from the antenna to the terminal device of the communication counterpart. Further, the RB information, including the modulation method, is transmitted to the terminal device if necessary.

### (Processing of Scheduler)

Next, the processing operation of the scheduler 21 of the MAC unit 2 will be described.

In order to acquire frequency diversity, the scheduler 21 specifies the number of each of RBs which are spaced apart from each other in frequency, and then sets the thus obtained RB numbers in the resource table 23. The RB numbers are set in the resource table 23 in order to reserve the RBs to be used.

In the case of dynamically allocating RBs of good radio quality, in order to acquire the frequency diversity, an RB of the best radio quality is selected from among RBs having lower frequencies than a BCH (Broadcast Channel) transmission bandwidth, and an RB of the best radio quality is selected from among RBs having higher frequencies then the BCH transmission bandwidth, and then the resource table 23 is overwritten with the RB numbers of the selected RBs. Whether the radio quality is good or not is determined by using the CQI received from the terminal device.

Further, a timing for selecting RBs is, in a case where a packet is a VoIP packet, may be, e.g., when there has been no user who uses the VoIP packet in the radio base station apparatus and a user who uses the VoIP packet appears, whereby a good radio quality can be achieved in the communication state.

Further, as long as frequency diversity can be acquired, RBs are not necessarily required to be divided based on the BCH transmission band into an RB having a lower frequency and an RB having higher frequency; while having a high and low frequency spaced apart from each other can be selected.

When the scheduler 21 schedules packet data, the scheduler 21 refers to the RB numbers stored in the resource table 23, and then allocates the packet data to the reserved RBs.

Next, the scheduler 21 performs distributed transmission of the packet data which has allocated to the reserved RBs based on persistent scheduling.

### (Persistent Scheduling: FIG. 3)

The allocation of RBs by persistent scheduling is shown in FIG. 3.

In FIG. 3, RBs for VoIP are used as the RBs. The RBs for VoIP are allocated in lower and higher frequency regions of a good radio quality, the lower and higher frequency regions having frequencies lower and higher than the BCH transmission band, and persistent allocation is performed multiple times to the corresponding regions.

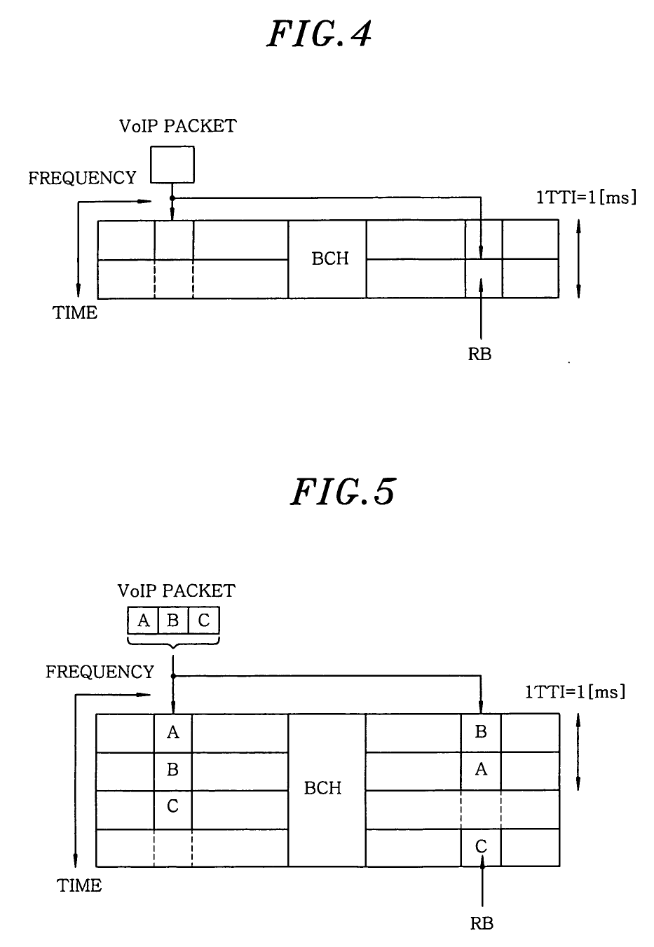

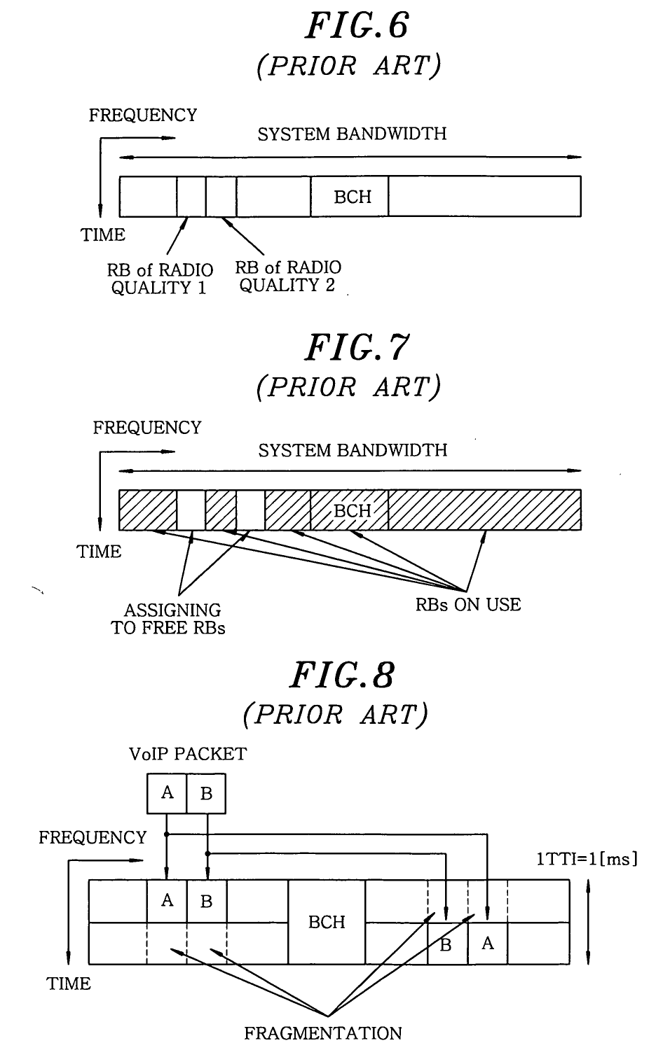

### (Distributed Transmission: FIG. 4)

The distributed transmission for a packet is shown in FIG. 4.

In the example in FIG. 4, configuration is made such that a single VoIP packet is distributed in separated regions on the frequency and the time axis, and then transmitted.

In the present embodiment, although packet data scheduling according to the above-described method can be used to handle various types of packet data, it is suitable for VoIP packet data, which is of a small amount but has a relatively large amount of control information.

The scheduling priority of the VoIP packet data is determined depending on the state of VoIP packet data in the descending order of the retransmission, scheduling at next TTI (Transmission Timing Interval), and new transmission. That is, retransmission has the highest priority thereamong

Further, when no VoIP packet data to be transmitted exists, and RBs corresponding to RB numbers which are reserved in the resource table 23 are not used, other packet data is allocated to the RBs corresponding to the reserved RB numbers.

### (When a Plurality of Packets is Generated at the Same Time: FIG. 5)

A method of scheduling RBs in a case where packets for a plurality of users are generated at the same time will be described with reference to FIG. 5.

When VoIP packet data for a plurality of users needs to be allocated at the same time, that is, when a plurality of pieces of VoIP packet data is sent from the RLC unit 1 to the MAC unit 2 at the same time, the resource table 23 is referred to first, and allocating is performed by using RBs corresponding to the reserved RB numbers. In case specific VoIP packet data exist which could not be scheduled on the RBs corresponding to the reserved RB numbers, the unscheduled VoIP packet data is scheduled at the next TTI.

Finally, when the VoIP packet data A, B and C arrive at the same time as shown in FIG. 5, persistent scheduling and a scheduling for distributed transmission are performed for the packet data A and B on the RBs corresponding to the reserved RB numbers in the resource table 23 within 1 TTI (=1 ms).

Further, for the VoIP packet data C for which the scheduling cannot be performed on the RB corresponding to the reserved RB number, the scheduling is delayed and then the distributed transmission scheduling is performed.

### EFFECT OF THE EMBODIMENT

The apparatus in accordance with the embodiment of the present invention performs the persistent scheduling and the distributed transmission on packet data. Therefore, overhead of control information can be reduced, utilization of resources can be improved, and frequency diversity can be acquired to thereby improve radio quality.

Further, with a use of the apparatus in accordance with the present invention, since the frequency diversity can be acquired by previously reserving two or more RBs spaced apart from each other in frequency by using persistent scheduling for a packet, there is an advantage of improving the radio quality.

Further, in the apparatus in accordance with the present invention, reservation is made on the resource table 23 by using RB numbers, so that there is an advantage in that schedule management for RBs can be simplified.

Further, when a plurality of users receives services, there are advantages in that fragmentation of RBs can be reduced by the persistent scheduling, so that the utilization of resources can be improved.

With a use of the apparatus in accordance with the present invention, there are advantages in that a reservation of RBs having a good radio quality and spaced apart from each other in frequency can be performed by only updating RB numbers in the resource table 23, so that reducing processing burden to schedule the RBs can be reduced, and radio quality can be further improved since transmission is performed by using RBs having good radio quality, while improving the radio quality by a frequency diversity.

The apparatus may be dedicatedly used in a system using OFDMA (orthogonal Frequency Division Multiple Access).

### INDUSTRIAL APPLICABILITY

The present invention is suitable for a radio base station apparatus capable of reducing processing burden, improving radio quality and raising utilization efficiency of radio resources

What is claimed is:

1. A radio base station apparatus, comprising:
a radio link control unit for outputting packet data to be transmitted to terminal devices;
a media access control unit for scheduling the packet data; and
a base band unit for processing baseband signals of a reception signal and a transmission signal;
wherein the media access control unit includes:
a resource table for storing resource block numbers in order to reserve resource blocks for the packet data;
a system information memory unit for storing a parameter used to determine whether to update information stored in the resource table; and
a scheduler for, when the parameter indicates update, selecting resource blocks spaced apart from each other in frequency and having good radio quality, updating the resource table by using resource block numbers corresponding to the selected resource blocks, and performing persistent scheduling and distributed transmission scheduling on the packet data by using the resource blocks corresponding to the resource block numbers stored in the resource table.
